(19) United States
(12) Patent Application Publication
(10) Pub. No.: US 2014/0324585 A1
(43) Pub. Date: Oct. 30, 2014

(54) APPARATUS, SYSTEMS, AND METHODS FOR PRODUCT CONTAINER PROGRAMMABLE DISPLAYS

(71) Applicant: Eric Mederos, Livermore, CA (US)

(72) Inventor: Eric Mederos, Livermore, CA (US)

(21) Appl. No.: 14/260,527

(22) Filed: Apr. 24, 2014

Related U.S. Application Data
(60) Provisional application No. 61/815,668, filed on Apr. 24, 2013.

(51) Int. Cl. G06Q 30/02; G09F 23/00

(52) U.S. Cl. CPC G06Q 30/0257; G09F 23/00; G09F 2023/0025
USPC 705/14.55

(57) ABSTRACT

A computer implemented method is disclosed for accessing a display circuit coupled to a product container. The method includes providing an application user interface on a mobile device. In response to a user launching the application, the user is prompted to access message content. A wireless link is then established between a display control circuit coupled to the product container and the mobile device. Message content is then wirelessly transferred between the display circuit and the mobile device via the wireless link.

### RELATED APPLICATION(S)

This application claims benefit of priority to Provisional U.S. Patent Application No. 61/815,668, filed Apr. 24, 2013, the aforementioned priority application being hereby incorporated by reference in its entirety.

### TECHNICAL FIELD

The disclosure herein relates to marketing methods and product displays, and more specifically to product containers with programmable message displays.

### BACKGROUND

Flexible display circuits, such as those associated with light emitting diodes (LEDs), provide an efficient and economical way to deliver message content on product containers. The messages may be private, such as for an individual event, or public, such as for product advertising. Attaching such a display to a product container delivers a directed message to a potential consumer in a memorable manner.

Conventional LED circuits applied to containers have provided an input interface to program the message content. The conventional interface has employed buttons attached to the display circuit to enable a user to specify symbols, such as letters and words, for display. While this programmability has proved useful, the interface is difficult to use, and limited in the types of messages that may be programmed.

Thus, the need exists for improved programmable message displays for product containers such as bottles.

### BRIEF DESCRIPTION OF THE DRAWINGS

Embodiments of the disclosure are illustrated by way of example, and not by way of limitation, in the figures of the accompanying drawings and in which like reference numerals refer to similar elements and in which:

FIG. 1 illustrates one embodiment of an LED display that is attached to a bottle, and having a wireless link established to a mobile device.

FIG. 2 illustrates one embodiment of an LED display circuit that employs the LED display of FIG. 1.

FIG. 3 illustrates an embodiment of a control circuit for use in the LED display circuit of FIG. 2.

FIG. 4 illustrates a flowchart of steps corresponding to one embodiment of a method of wirelessly programming the display circuit of FIG. 2.

FIG. 5 illustrates a flowchart of steps corresponding to one embodiment of a method of displaying message content from the LED display circuit to a user's mobile device.

FIG. 6 illustrates a web-based platform for uploading and downloading message content to multiple containers having the LED display circuits of FIG. 2.

### DETAILED DESCRIPTION

Embodiments of computer implemented methods, display systems, and web platforms are disclosed herein. One embodiment of a computer implemented method is disclosed for accessing a display circuit coupled to a product container. The method includes providing an application user interface on a mobile device. In response to a user launching the application, the user is prompted to access message content. A wireless link is then established between a display control circuit coupled to the product container and the mobile device. Message content is then wirelessly transferred between the display circuit and the mobile device via the wireless link.

In a further embodiment, a display system is disclosed including a product container and a display circuit coupled to the container. The display circuit includes an LED display, a control circuit coupled to the display, and memory to store programmed message content. A wireless interface coupled to the memory and the control circuit establishes a wireless link with a mobile device in response to launch of an application associated with the display system.

In yet another embodiment, a web-based advertising platform is disclosed. The platform includes a website for communicating marketing information associated with a bottled product to potential consumers of the bottled product. The website includes an upload interface for receiving message content, and a download interface for transmitting message content. The web-based advertising platform further includes at least one bottle corresponding to the bottled product. The bottle couples to a display circuit that includes an LED display, a control circuit, and memory to store programmed message content. A wireless interface coupled to the memory and the control circuit establishes a wireless link with the website via at least one of the upload interface or download interface.

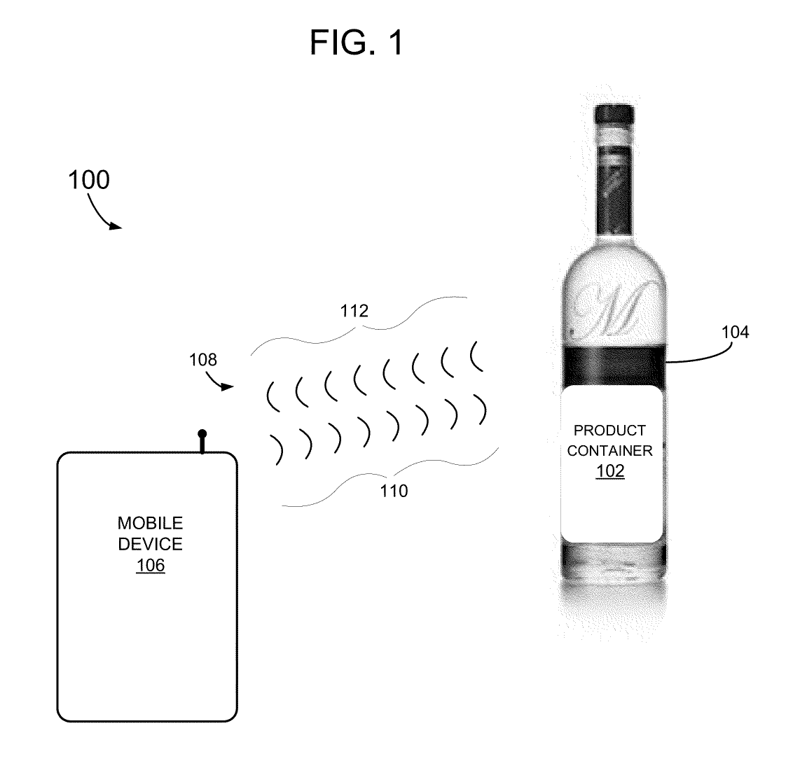

FIG. 1 illustrates one embodiment of a display system, generally designated 100, that displays message content on a product container 102, such as a bottle for storing spirits. A display circuit 104 attached to the bottle displays the message content. The content may be customized and programmed via a mobile device 106 that wirelessly interfaces with the display circuit via a wireless link 108. For some embodiments, the wireless link may include an uplink 110 that facilitates wireless transmission of the message content to the container 102. Other embodiments may also provide for a downlink 112 to enable transmissions from the container 102 to the mobile device 106. Further referring to FIG. 1, the mobile device may take the form of a laptop computer, tablet computer, mobile telephone or smartphone, to name but a few.

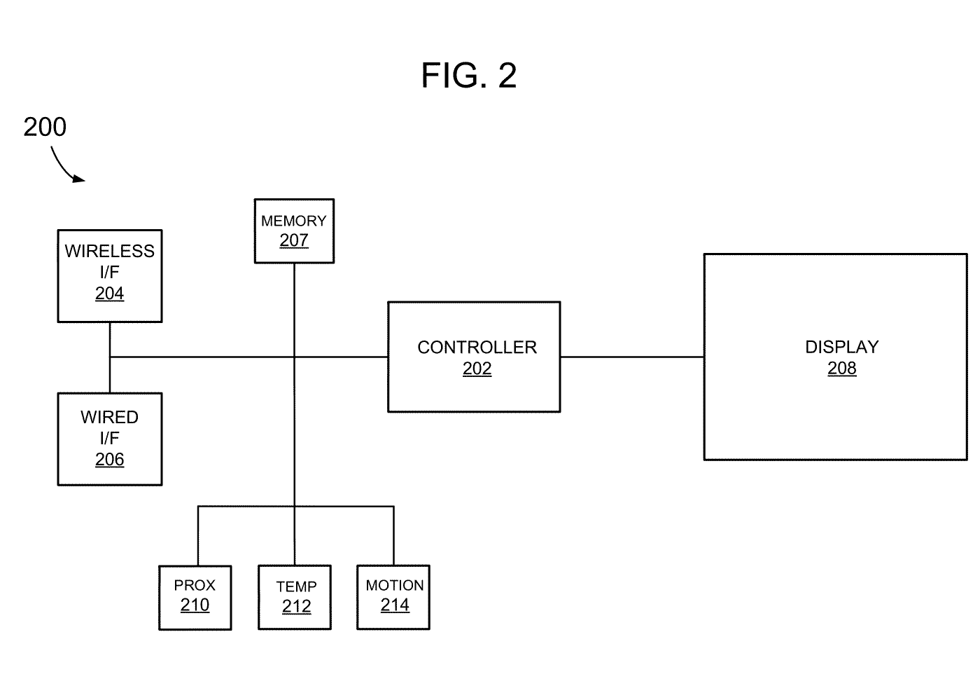

One specific embodiment of a display circuit that may be employed by the product container 102 is shown in FIG. 2, and generally designated 200. The display circuit includes a controller 202 that may take the form of a processor or micro-controller. The controller 202 couples to a display 208. The display may be of varying size and comprised of LEDs of various colors. The display may be used for advertising, displaying various images or messages. For example, messages may include greetings, calendar events (such as birthdays, anniversaries, holiday messages, events of cultural significance, etc.). The messages may be shown in any language. Optionally, the display may utilize animated images or messages. For example, messages may scroll from any direction, strobe, glow, etc. In some embodiments the LED display may range in size from covering a portion of the bottle face to the entire bottle face in all angles (0 degrees to 360 degrees).

In some embodiments a holographic or other three dimensional image may be projected within the bottle, appearing to a viewer as enclosed by the bottle. In such an embodiment, the holographic or three dimensional image may be projected from the base of the bottle. In other embodiments the holographic or three dimensional image may be projected to the interior of the bottle surface. In yet other embodiments, the holographic or three dimensional image may appear to a viewer as appearing outside the bottle surface. In all embodiments, the holographic or three dimensional image may be static or dynamic.

In some embodiments the display may comprise a separate device that is attached to a container. For example, the LEDs may be on a clip conforming to the shape of the container and attached thereto, such as by wrapping or snapping onto a container (e.g., a bottle). Such a device may adapt to any shape or size of container. Optionally, such a display may be flexible screen or comprise flexible image film technology to wrap around or as a “sleeve” to any bottle or container or product wrapper. Optionally, such displays may be interchangeable between bottles and be associated with the new container or bottle it is attached to.

Other embodiments may include a display molded onto the outer surface of the container or embedded within the material comprising the container such that the display is visible when viewing the container. The display may be powered using a power source, such as a battery, solar cells, or other similar power sources.

The portable display may allow the container to receive and communicate or display a message. Such communications may be from container to container, container to smartphone, computer, tablet, etc., or container to a local router. Messages may be received or transmitted through specific channels, either locally or over a longer distance.

Interface circuitry in the form of a wireless interface 204 and a wired interface 206 enable the display circuit to communicate with the mobile device 106. For one embodiment, the wireless interface includes a radio and associated antenna to communicate with the mobile device via a wireless link using, for example, a Bluetooth protocol. Other exemplary wireless connections may include Bluetooth low energy (BLE), Near Field Communication (NFC), WiFi, IR, Linux wireless, any other low frequency RF modulation, microwave, radar, or other similar connections. Wireless connections may include ranges of various transmission frequencies ranging from 0 Hz to Infinite Thz. Exemplary wireless frequency transmission ranges may include the following:

| | | |
|---|---|---|
| subHz | <3 Hz | SubHertz |
| ELF | 3 Hz-30 Hz | Extremely Low Frequency |
| SLF | 20 Hz-300 Hz | Super Low Frequency |
| ULF | 300 Hz-3 kHz | Ultra Low Frequency |
| VLF | 3 kHz-30 kHz | Very Low Frequency |
| LF | 30 kHz-300 kHz | Low Frequency |
| MF | 300 kHz-3 MHz | Medium Frequency |
| HF | 3 MHz-30 MHz | High Frequency |
| VHF | 30 MHz-300 MHz | Very High Frequency |
| UHF | 300 MHz-3 GHz | Ultra High Frequency |
| SHF | 3 GHZ-30 GHz | Super High Frequency |
| EHF | 30 GHz-300 GHz | Extremely High Frequency |
| Sub-M | 300 Ghz-Infinite THz | Sub Millimeter |

With continued reference to FIG. 2, exemplary wired connections may include USB, Micro USB, Mini USB, IEEE 1394 (such as Firewire), or other similar connections. Optionally, an embodiment may include an input device on the container to allow instructions to be provided or programmed or to receive the input of a message to be shown on the display. The input device may comprise an off switch to turn off the display, enter buttons (or other input buttons), alphanumeric characters (e.g., all letters and numbers), and other similar inputs. Other embodiments may include characters for various languages.

In another embodiment, the container may include receivers, transmitters, transceivers, proximity sensors, motion sensors, global positioning system (GPS) receivers, or other similar devices to enable the sending and receiving of information. Such devices may be electrically connected to a processor for interpreting the data or providing it to other components such as the display.

While the following embodiments describe the invention in relation to beverage containers (e.g., bottles for alcoholic or non-alcoholic beverages, glasses, cups, etc.), it should be understood that the invention is not solely limited to these embodiments and may be applied to other containers or product surface areas. In the embodiments described below, the container may be comprised of various material, such as aluminum, plastic, glass, ceramic, metal, crystal, or other similar materials.

Further referring to FIG. 2, message content communicated to the display circuit 200 may be stored in a memory 207. The memory may comprise non-volatile or volatile storage to store various programmed messages received from the mobile device.

In some embodiments, a variety of sensors are employed by the display circuit. The sensors may include, for example, a proximity sensor 210 to detect a mobile device of a potential consumer, and send a message to the mobile device or otherwise show a message to the display. For example, a bottle may detect a customer's phone in a bar through an installed mobile application and send an advertisement to the phone or display a greeting through the LED display on the bottle. Optionally, such messages may be sent through various social media platforms (e.g., Facebook, Twitter, etc.). A temperature sensor 212 may be provided to indicate a temperature of the container contents on the product container. A motion sensor 214 may also be provided to detect movement of the product container. Such motion sensors may be connected to transmitters or receivers on the bottle to provide information to social media platforms or mobile device applications as the bottle is poured or the display activated.

In some embodiments, the receivers and transmitters may be daisy chained. For example, an embodiment may allow communication from a bottle, to an application to social networks, to another bottle, etc., including any combination or permutation thereof.

Exemplary embodiments of containers may include mechanical gyrators or motion sensing on/off switches to keep track of the weight of the contents or the amount of liquid in a bottle. Such sensors may be placed anywhere in the bottle. The sensors may be connected to a transmitter which may signal the amount of liquid in the bottle along with the liquid specificity range for the liquid.

In other embodiments, the product container may include a microphone and speakers to receive audio commands or transmit audio, such as messages or music, which may accompany the display.

Optionally, the display circuit controller 202 may be configurable, and provide for different modes or settings (e.g., private, broadcast, etc.) for the product container display. The settings may be preprogrammed or controlled by the people who have possession of the bottles. For example, a private mode may be enabled by a couple having a private dinner and would like control over the bottle without other parties displaying messages on their bottle. In another example, the broadcast mode may be used in various situations (e.g., at sporting events, social gatherings, bars, or other similar events) to show messages, run contests, advertisements, or other similar uses.

In one embodiment, the display system may be used as an indicator in a contest. For example, at a large sporting event (e.g., football, basketball, hockey, baseball game, etc.) a sponsor may hold a contest through entering a code through an input device on the beverage container. All participating containers may have their displays light up, the containers for all participants aside from the winner may display the same image or color (e.g., blue). The winner's container may display a unique image or color (e.g., red) to signify they won.

Other embodiments of the container with communication capabilities (i.e., through the receivers, transmitters, or other similar devices) may allow the container to communicate with other containers. For example, the container may send viral messages, images, advertisements etc. Optionally, the communications may enable social games as described below.

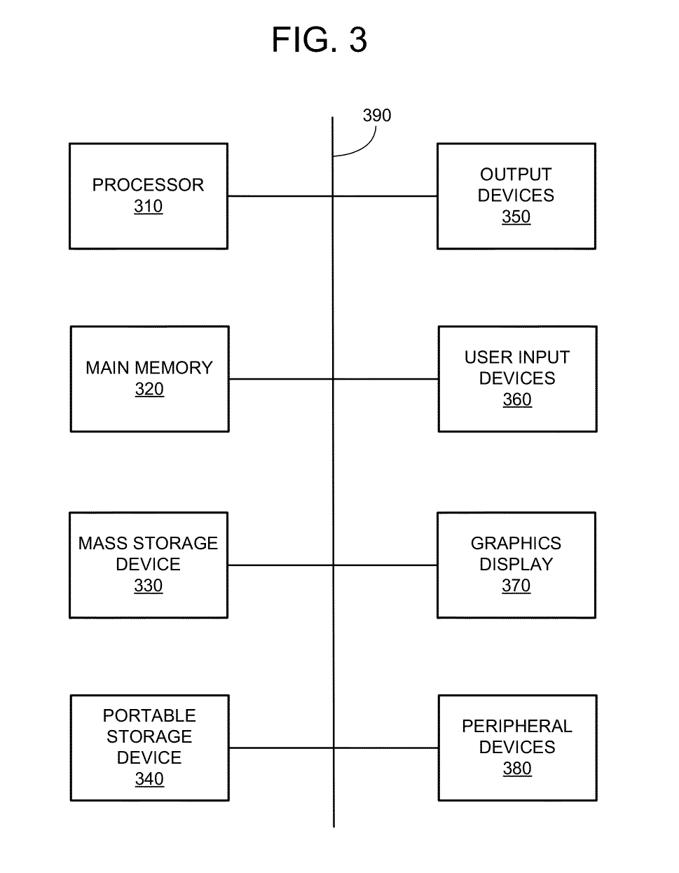

Various embodiments may include a downloadable application for a mobile device, as described in FIG. 3 below. For example, the mobile device may be realized as an Android, iPhone, or Blackberry device capable of running a software application (e.g., Android Smart Bottle software App, iPhone Smart Bottle software App, Blackberry Smart Bottle software App, etc.). The application may allow a user to wirelessly program an individual container or bottle directly through the mobile device. In other embodiments, the bottle display may be controlled through hands-free voice commands. Similarly, the application may be operated by voice commands.

In one embodiment, the invention may include a social media experience. The container may utilize the wireless connection and receive or download a program or application for entertainment, e.g. a drinking game such as Scategories®.

Referring now to FIG. 3, one embodiment of a mobile computing system architecture 300 is shown. The system may be implemented in the contexts of the likes of computing systems, networks, servers, or combinations thereof. The system 300 may include one or more processors 310 and main memory 320. Main memory 320 stores, in part, instructions and data for execution by processor 310. Main memory 320 may store the executable code when in operation. The system 300 may further includes a mass storage device 330, portable storage device(s) 340, output devices 350, user input devices 360, a graphics display 370, and peripheral device(s) 380.

The components shown in FIG. 3 are depicted as being connected via a single bus 390. The components may be connected through one or more data transport means. Processor 310 and main memory 320 may be connected via a local microprocessor bus, and the mass storage device 330, peripheral device(s) 380, portable storage device 340, and graphics display 370 may be connected via one or more input/output (I/O) buses.

Mass storage device 330, which may be implemented with a magnetic disk drive or an optical disk drive, is a non-volatile storage device for storing data and instructions for use by processor 310. Mass storage device 330 may store the system software for implementing embodiments of the present invention for purposes of loading that software into main memory 320.

Portable storage device 340 operates in conjunction with a portable non-volatile storage medium, such as a floppy disk, compact disk, digital video disc, or USB storage device, to input and output data and code to and from the system. The system software for implementing embodiments of the present invention may be stored on such a portable medium and input to the system 300 via the portable storage device 340.

User input devices 360 provide a portion of a user interface. User input devices 360 may include one or more microphones, an alphanumeric keypad, such as a keyboard, for inputting alpha-numeric and other information, or a pointing device, such as a mouse, a trackball, stylus, or cursor direction keys. User input devices 360 may also include a touchscreen. Additionally, the system 300 as shown in FIG. 3 includes output devices 350. Suitable output devices include speakers, printers, network interfaces, and monitors.

Graphics display 370 may include a liquid crystal display (LCD) or other suitable display device. Graphics display 370 receives textual and graphical information, and processes the information for output to the display device.

Peripheral devices 380 may be included and may include any type of computer support device to add additional functionality to the computer system.

The components provided in the system 300 are those typically found in computer systems that may be suitable for use with embodiments of the present invention and are intended to represent a broad category of such computer components that are well known in the art. Thus, the system 300 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including UNIX, LINUX, WINDOWS, MAC OS, PALM OS, ANDROID, IOS (known as IPHONE OS before June 2010), QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), BLUE-RAY DISC (BD), any other optical storage medium, RAM, PROM, EPROM, EEPROM, FLASH memory, and/or any other memory chip, module, or cartridge.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

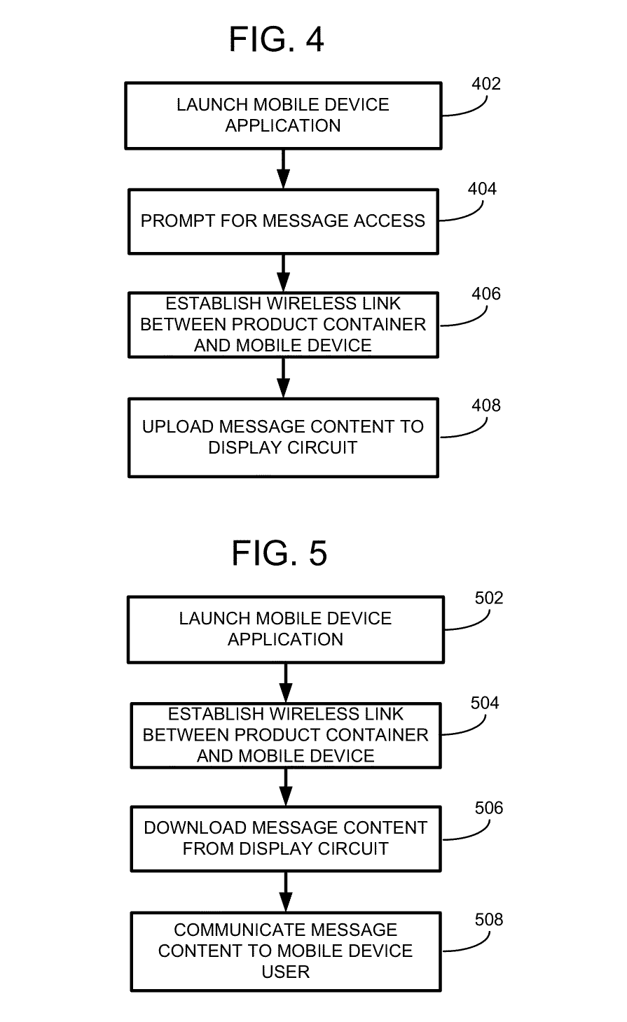

For one specific embodiment, the computer program code takes the form of an application resident on the mobile device, that when launched, enables communication with the product container display circuit. The application may provide a series of prompts on various screens for the user to read, and may communicate various marketing aspects associated with the product to the user. FIGS. 4 and 5 illustrate methods that may be employed by the software application to provide communication between the potential consumer and the product container display circuit.

With reference now to FIG. 4, a user desiring to program message content into the display circuit first launches the mobile device application, at 402. Once initiated, the application then may prompt the user, at 404, to access pre-programmed content already stored in the memory of the display circuit, or enable the user to generate a customized message by, for example, prompting the user to type words into a screen. For customized messages created by the user, the mobile device then establishes a wireless link with the display circuit, at 406. Once the wireless link is established, the message content may be uploaded or transferred from the mobile device to the display circuit, at 408. Although the steps above have been described in the context of a wireless link, wired access is carried out in a similar manner.

FIG. 5 illustrates a method similar to the steps described above with respect to FIG. 4, but involving downloading of message content from the display circuit to the mobile device. In this scenario, the product maker or distributor may have pre-programmed one or more various messages in the display circuit memory. The messages may involve advertising of the product. When the product-related mobile application is launched, at 502, and a wireless link established, at 504, the message content may be downloaded to the consumer's mobile device, at 506. The message may then be displayed on the mobile device display, at 508, or otherwise communicated to the consumer.

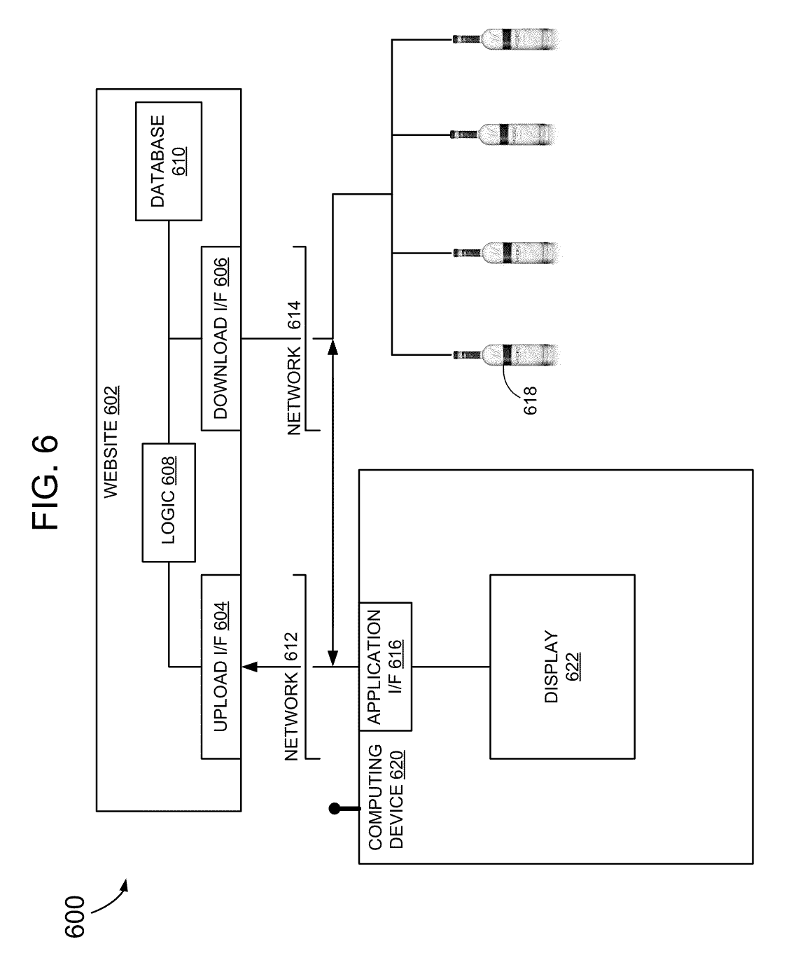

Referring now to FIG. 6, in another embodiment, the marketing channel may comprise a web-based advertising platform, generally designated 600. The web-based advertising platform includes a website 602 that includes an upload interface 604 and a download interface 606. Server logic 608 controls the interfaces and stores various advertising-related content in a database 610. The upload and download interfaces 604 and 606 couple to respective networks 612 and 614.

Further referring to FIG. 6, a mobile computing device 620, such as that described with respect to FIG. 3, includes an application interface 616 that accesses either of the networks 612 and 614 to communicate with the platform 600 via the upload interface 604 or the download interface 606. One or more product containers 618 periodically access the network 614 to determine the availability of advertising opportunities to consumers. Consistent with the embodiments described above, in some circumstances, the product containers may detect the proximity of a potential consumer, and communicate the information to the web advertising platform 602. Message content may then be sent from the platform to the mobile device, and displayed on a display 622 associated with the mobile device. Many other possible applications for the web-based advertising platform to establish communication between a product maker and a potential consumer are described below.

With continued reference to FIG. 6, the web platform 600 may be configured to enable turning each container into a billboard, offer advertisements directly on the web platform, or offer downloadable applications right to the container itself. Optionally, the web platform may control the marketing channel by selling access to the channel. For example, the containers may be preprogrammed to only receive advertisements on transmission of a specific pin or code. In another example, the web platform may have accounts and grant authorization to specific accounts to send advertisements to containers. In another embodiment, the web platform may be a place people go to 1) program bottles or containers, 2) interact with other people, and 3) manage their applications. The web platform may allow programmers to build and sell their own applications for the containers or bottles.

In various embodiments, an alternate centralized system and method for channel control may be used (e.g., Centralized Medea Ad Space Channel). Such a centralized system may control messages to individual, segmented, targeted, and universal containers/bottles and vendors. Optionally, the system may allow cross selling of advertisement space on the containers to non-alcoholic or various product types. For example, ad space may be sold on alcoholic bottles to Mercedes, Coca-Cola, etc.

Optionally, bottles or containers may communicate with a mobile device to form an inventory control system. For example, one embodiment may include an inventory control system application. The application may receive the input of a code from a shipment of a case of bottles into a computing device or mobile device. The input may be accomplished through manually entering a code, scanning or taking a picture of a barcode, QR code, or other commercial code. Optionally, the input may be done to a website instead of an application. The sensors, as described above, on the bottle may monitor the level of the contents or the number of bottles left. Messages may be transmitted to the mobile device indicating that the bottle level is low and to get a new bottle ready.

Additionally, when the shipment is about to run out (e.g., only one or two bottles remain) a message may be displayed on the mobile device to order more. Optionally, the message may include an offer to send the order request directly to a distributor to provide another shipment. Thus, reducing the hassle of taking stock and ordering. In one embodiment the application may further assist in inventory management or serve as a software inventory reader. For example, the application may compile and display additional information, such as how long it took to go through a shipment for a particular beverage, how many bottles are left, etc. Thereby assisting a user in determining demand.

In an alternate embodiment, when the sensors on a bottle indicate that the bottle's contents are low, the application may facilitate direct online ordering. Such direct online ordering may occur as the bottle sensors transmit a message to the application that the bottle is nearly empty. The application may then offer to scan an identifier to purchase a new bottle.

In one embodiment, the electronics comprising the receiver, transmitter, processor, and power source may be located on the bottom of the bottle. Other locations may also be used, such as a groove or indention on the bottle. The electronics may be sealed to prevent moisture from interfering or degrading operation.

Another embodiment may include an exterior platform to serve as a base. Such a platform may be configured to connect with the containers or bottles as described above. Embodiments of the platform may include sensors, projectors, wireless transmission components, transceivers, or other similar components to the bottles as described above. Exemplary platforms may include shelves, counters, table tops, coasters, bar shelves, or other similar platforms for display or storage of beverage bottles.

The platform or base may, through the proximity sensors or transceivers, identify and connect to containers or bottles placed on or married to it. For example, a coaster serving as a base may identify a specific container or bottle placed upon it. The base may then transmit images to the bottle or assist in connecting the bottle to other bottles.

In an optional embodiment, the platform or base may also project a holographic or three dimensional image within the bottle or off the bottle similar to methods described above. Other embodiments may incorporate the projection of sounds through speakers or control the display of images by the bottle or container.

In another embodiment, a platform or base may identify and connect to multiple containers or bottles. In such a scenario, the platform or base may serve as a control system or brain to synchronize the displays of the containers or bottles such that they may serve as a single synchronized display. For example, if five bottles are placed in a row, a message or image may scroll from the display across all bottles rather than a single bottle. The platform may also take into account the position of the bottles such that the display proceeds uninterrupted. For example, only showing the message or image across the viewable portion of the display and not the portion hidden by a curve of the bottle or identifying when a bottle is removed and continuing the message or image across the remaining bottles and omitting the removed bottle.

In another embodiment, the platform may serve as a charging station for the containers placed on or within it. Such a charging station may operate on wired connection to the containers or wireless charging through induction.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

We claim:

1. A non-transitory computer implemented method for accessing a display circuit coupled to a container, the method comprising:
providing an application user interface on a mobile device;
prompting a user, via the application user interface, to access message content, the prompting carried out in response to the user opening the application;
establishing a wireless link between a display control circuit coupled to the container and the mobile device; and
wirelessly transferring message content between the display circuit and the mobile device via the wireless link.

2. The non-transitory computer implemented method according to claim 1, wherein:
the accessing the message content includes prompting the user to generate a message for display by the display circuit; and
uploading the generated message to the display circuit via the wireless link.

3. The non-transitory computer implemented method according to claim 2, further comprising:
storing the uploaded message in a memory coupled to the display control circuit; and
displaying the message on a display coupled to the display circuit.

4. The non-transitory computer implemented method according to claim 1, wherein:
the accessing the message content includes prompting the user to receive a message stored by the display circuit; and
downloading the stored message from the display circuit to the mobile device via the wireless link.

5. The non-transitory computer implemented method according to claim 4, wherein downloading the stored message further comprises:
viewing the stored message on a display associated with the mobile device.

6. The non-transitory computer implemented method according to claim 4, wherein:
downloading the stored message comprises downloading a link to a web page providing detailed marketing content associated with the container.

7. The non-transitory computer implemented method according to claim 1, wherein the establishing a wireless link comprises pairing the mobile device to the display circuit via a Bluetooth wireless protocol.

8. A display system comprising:
a container;
a display circuit coupled to the container, the display circuit including
an LED display,
a control circuit coupled to the display,
memory to store programmed message content, and
a wireless interface coupled to the memory and the control circuit, the wireless interface to establish a wireless link with a mobile device in response to launching of an application associated with the display system.

9. The display system of claim 7, wherein the wireless interface further includes:
a Bluetooth radio to establish the wireless link via a Bluetooth communications protocol.

10. The display system of claim 8, wherein the control circuit further comprises:
a sensor to detect at least one parameter from the group comprised of proximity, temperature and motion; and
wherein communication between the display system and the mobile device involves data generated by the sensor.

11. The display system of claim 8, wherein the programmed message content comprises a pre-programmed web link, and wherein the wireless interface is configured to transmit the web link to the mobile device for viewing via the mobile application.

12. The display system of claim 8, wherein the wireless interface is configured to enable access to the display circuit via a web platform.

13. The display system of claim 12, wherein the web platform downloads message content to the display circuit via the wireless interface.

14. A web-based advertising platform comprising:
a website for communicating marketing information associated with a bottled product to potential consumers of the bottled product, the website having an upload interface for receiving message content, and a download interface for transmitting message content;
at least one bottle corresponding to the bottled product, the at least one bottle coupled to a display circuit, the display circuit for each bottle including
an LED display,
a control circuit coupled to the display,
memory to store programmed message content, and
a wireless interface coupled to the memory and the control circuit, the wireless interface to establish a wireless link with the website via at least one of the upload interface or download interface.

15. The web-based advertising platform of claim 14, wherein the wireless interface for each display circuit is further configured to communicate with a mobile device in response to launch of an application associated with the display circuit.

16. The web-based advertising platform of claim 14, wherein the control circuit further comprises:
a sensor to detect at least one parameter from the group comprised of proximity, temperature and motion; and
wherein communication between the display system and the mobile device involves data generated by the sensor.

17. The web-based advertising platform of claim 14, wherein the wireless interface is configured to enable access to the display circuit via the website.
